(19) United States
(12) Patent Application Publication
(10) Pub. No.: US 2015/0351153 A1
(43) Pub. Date: Dec. 3, 2015

(54) ENHANCED PHYSICAL HARQ INDICATOR CHANNEL DECODING

(71) Applicant: QUALCOMM Incorporated, San Diego, CA (US)

(72) Inventors: Vasanth Kumar Ramkumar, San Diego, CA (US); Deepak Krishnamoorthi, San Diego, CA (US); Navid Ehsan, San Diego, CA (US); Srinivasan Rajagopalan, San Diego, CA (US); Bao Vinh Nguyen, San Diego, CA (US)

(21) Appl. No.: 14/723,850

(22) Filed: May 28, 2015

Related U.S. Application Data
(60) Provisional application No. 62/005,459, filed on May 30, 2014.

(51) Int. Cl. H04W 76/04; H04L 5/00; H04W 74/00; H04L 1/18

(52) U.S. Cl. CPC H04W 76/048; H04L 1/1861; H04L 5/0048; H04W 74/004

(57) ABSTRACT

Methods, systems, and devices are described for improving discontinuous reception (DRX) periods using enhanced physical HARQ indicator channel (PHICH) decoding. A user equipment (UE) may determine that an uplink (UL) retransmission (ReTx) is unnecessary based on the content of the original UL transmission. For example, the transmission may include media access control (MAC) layer padding rather than relevant application layer data. The UE may then identify a DRX sleep period that includes the subframe where the ReTx would take place. In some cases, the DRX sleep period may include a subframe where the UE would otherwise receive an acknowledgement message (AM) from a base station. The UE may then enter a DRX sleep state. In another example, the DRX sleep period is based on the content of a received AM. If the UE receives an ACK, the UL ReTx may be unnecessary.

### CROSS REFERENCES

The present application for patent claims priority to U.S. Provisional Patent Application No. 62/005,459 by Ramkumar et al., entitled “Enhanced Physical HARQ Indicator Channel Decoding,” filed May 30, 2014, assigned to the assignee hereof, and expressly incorporated by reference herein.

### FIELD OF DISCLOSURE

The following relates generally to wireless communication, and more specifically to improving discontinuous reception (DRX) periods using enhanced physical HARQ indicator channel (PHICH) decoding.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems (e.g., a Long Term Evolution (LTE) system).

Generally, a wireless multiple-access communications system may include a number of base stations, each simultaneously supporting communication for multiple mobile devices or other user equipment (UE) devices. Base stations may communicate with UEs on downstream and upstream links. Each base station has a coverage range, which may be referred to as the coverage area of the cell. When the UE does not have data to transmit or receive, it may enter an inactive state, known as a DRX sleep state, to conserve power. However, in some cases the DRX sleep period may not be efficient. For example, in some cases a UE may awake from a sleep state to transmit or receive unnecessary data. Thus, methods for improving DRX periods are desired.

### SUMMARY

The described features generally relate to one or more systems, methods, and/or apparatuses for improving discontinuous reception (DRX) periods using enhanced physical HARQ indicator channel (PHICH) decoding. A user equipment (UE) may determine that an uplink (UL) retransmission (ReTx) is unnecessary based on the content of the original UL transmission. For example, the transmission may include media access control (MAC) layer padding rather than application layer data (e.g., relevant application layer data). The UE may then identify a DRX sleep period that includes the subframe where the ReTx would take place. In some cases, the DRX sleep period may include a subframe where the UE would otherwise receive an acknowledgement message (AM) (e.g., a negative ACK message (NACKM) indicating unsuccessful receipt of transmission, or a positive ACK message (ACKM) indicating successful receipt of transmission) from a base station. The UE may then enter a DRX sleep state for the DRX sleep period. In another example, the DRX sleep period is based on the content of a received AM. If the UE receives an ACKM, the UL ReTx may be unnecessary.

A method of enhanced PHICH decoding is described, the method comprising determining that an UL retransmission for a HARQ process is unnecessary based on the content of one or more messages associated with the HARQ process, identifying a DRX sleep period based at least in part on the determination, and entering a DRX sleep state for the DRX sleep period.

An apparatus for enhanced PHICH decoding is described, the apparatus comprising means for determining that an UL retransmission for a HARQ process is unnecessary based on the content of one or more messages associated with the HARQ process, means for identifying a DRX sleep period based at least in part on the determination, and means for entering a DRX sleep state for the DRX sleep period.

An apparatus for enhanced PHICH decoding is described, the apparatus comprising a processor, memory in electronic communication with the processor, and instructions stored in the memory, the instructions being executable by the processor to determine that an UL retransmission for a HARQ process is unnecessary based on the content of one or more messages associated with the HARQ process, identify a DRX sleep period based at least in part on the determination, and enter a DRX sleep state for the DRX sleep period.

A non-transitory computer-readable medium for enhanced PHICH decoding is also described, the non-transitory computer-readable medium storing code for wireless communication at a UE, the code comprising instructions executable by a processor to determine that an UL retransmission for a HARQ process is unnecessary based on the content of one or more messages associated with the HARQ process, identify a DRX sleep period based at least in part on the determination, and enter a DRX sleep state for the DRX sleep period. In some examples the DRX sleep period includes an UL retransmission subframe for the HARQ process.

In some examples of the method, apparatuses, or non-transitory computer-readable medium described above the one or more messages includes an UL transmission and the content comprises MAC layer data. In some examples the DRX sleep period includes a PHICH subframe for the HARQ process.

In some examples of the method, apparatuses, or non-transitory computer-readable medium described above determining that an UL retransmission for a HARQ process is unnecessary comprises determining that the MAC layer data includes MAC layer padding data. In some examples the content includes non-application data. In some cases the content includes non-application data.

In some examples of the method, apparatuses, or non-transitory computer-readable medium described above the DRX sleep period comprises subframes between an acknowledgement message (AM) associated with the HARQ process and a new HARQ process. In some cases the DRX sleep period comprises subframes between an uplink transmission associated with the HARQ process and a new HARQ process.

In some examples of the method, apparatuses, or non-transitory computer-readable medium described above the one or more messages includes an AM message associated with the HARQ process. In some examples determining that the ACKM was transmitted without an indication of an adaptive retransmission associated with the HARQ process.

Some examples of the method, apparatuses, or non-transitory computer-readable medium described above may further comprise the HARQ process is a frequency division duplex (FDD) synchronous HARQ process with a delay of four (4) subframes. In some examples the DRX sleep period is 7 subframes.

In some examples of the method, apparatuses, or non-transitory computer-readable medium described above the DRX sleep period is 11 subframes. Some examples of the method, apparatuses, or computer program product described above include entering a DRX active state after the DRX sleep period.

In some examples of the method, apparatuses, or non-transitory computer-readable medium described above the DRX sleep period includes a downlink (DL) AM subframe associated with the HARQ process.

Further scope of the applicability of the described methods and apparatuses will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communications system in accordance with various embodiments.

FIG. 2 illustrates an example of a wireless communication process for enhanced PHICH decoding in accordance with various embodiments.

FIG. 3 illustrates an example of a DRX sleep schedule based on enhanced PHICH decoding in accordance with various embodiments.

FIG. 4 shows a block diagram of a device for enhanced PHICH decoding in accordance with various embodiments.

FIG. 5 shows a block diagram of a device for enhanced PHICH decoding in accordance with various embodiments.

FIG. 6 shows a block diagram of a device for enhanced PHICH decoding in accordance with various embodiments.

FIG. 7 illustrates a block diagram of a system for enhanced PHICH decoding in accordance with various embodiments.

FIG. 8 shows a flowchart illustrating a method for enhanced PHICH decoding in accordance with various embodiments.

FIG. 9 shows a flowchart illustrating a method for enhanced PHICH decoding in accordance with various embodiments.

FIG. 10 shows a flowchart illustrating a method for enhanced PHICH decoding in accordance with various embodiments.

### DETAILED DESCRIPTION

The described features generally relate to one or more improved systems, methods, and/or apparatuses to improve discontinuous reception (DRX) periods using enhanced physical HARQ indicator channel (PHICH) decoding. A user equipment (UE) may determine that an uplink (UL) retransmission (ReTx) is unnecessary based on the content of the original UL transmission. For example, the transmission may include media access control (MAC) layer padding rather than application layer data (e.g., relevant application layer data). The UE may identify a DRX sleep period that includes the subframe where the ReTx would take place. In some cases, the DRX sleep period may include a subframe where the UE would otherwise receive an acknowledgement message (AM) from a base station. The UE may enter a DRX sleep state. In another example, the DRX sleep period is based on the content of a received AM. If the UE receives an ACKM, the UL ReTx may be unnecessary.

The systems, methods, and/or apparatuses described may prevent wakeups (e.g., unnecessary wakeups) during DRX sleep periods (e.g., or off-cycles) using decode PHICH decoding and/or scheduling UL ReTx. Thus, the length of the DRX sleep periods may be increased. By increasing the DRX sleep period, a UE may conserve more power.

The following description provides examples, and is not limiting of the scope, applicability, or configuration set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

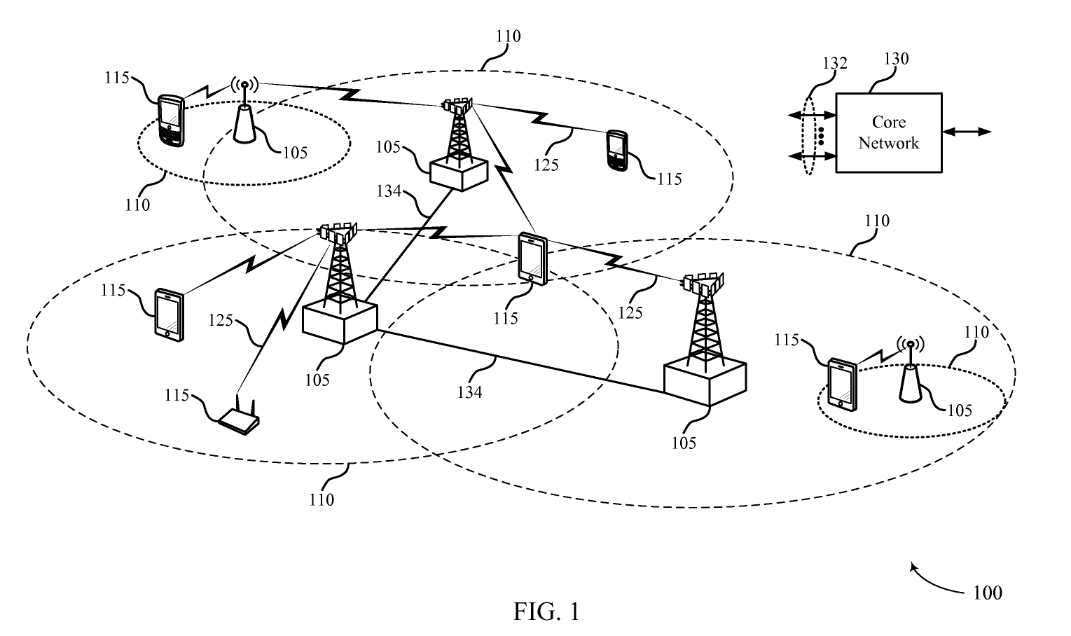

FIG. 1 illustrates an example of a wireless communications system 100 in accordance with various embodiments. The wireless communications system 100 includes base stations 105, communication devices, also known as a user equipment UE 115, and a core network 130. The base stations 105 may communicate with the UEs 115 under the control of a base station controller (not shown), which may be part of the core network 130 or the base stations 105 in various embodiments. Base stations 105 may communicate control information and/or user data with the core network 130 through backhaul links 132. In embodiments, the base stations 105 may communicate, either directly or indirectly, with each other over backhaul links 134, which may be wired or wireless communication links. The wireless communications system 100 may support operation on multiple carriers (waveform signals of different frequencies). Wireless communication links 125 may be modulated according to various radio technologies. Each modulated signal may carry control information (e.g., reference signals, control channels, etc.), overhead information, data, etc.

The base stations 105 may wirelessly communicate with the UEs 115 via one or more base station antennas. Each of the base station 105 sites may provide communication coverage for a respective geographic (e.g., coverage) area 110. In some embodiments, base stations 105 may be referred to as a base transceiver station, a radio base station, an access point, a radio transceiver, a basic service set (BSS), an extended service set (ESS), a NodeB, evolved node B (eNB), Home NodeB, a Home eNodeB, or some other suitable terminology. The coverage area 110 for a base station may be divided into sectors making up only a portion of the coverage area (not shown). The wireless communications system 100 may include base stations 105 of different types (e.g., macro, micro, and/or pico base stations, etc.). There may be overlapping coverage areas for different technologies.

The wireless communications system 100 may be a Heterogeneous Long Term Evolution (LTE)/LTE-A network in which different types of base stations provide coverage for various geographical regions. For example, each base station 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home, etc.) and, in addition to unrestricted access, may also provide restricted access by UEs having an association with the femto cell.

The core network 130 may communicate with the base stations 105 via a backhaul 132 (e.g., S1, etc.). The base stations 105 may also communicate with one another, e.g., directly or indirectly via backhaul links 134 (e.g., X2, etc.) and/or via backhaul links 132 (e.g., through core network 130). The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The UEs 115 may be dispersed throughout the wireless communications system 100, and each UE may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The communication links 125 shown in wireless communications system 100 may include uplink (UL) transmissions from a UE 115 to a base station 105, and/or downlink (DL) transmissions, from a base station 105 to a UE 115 over DL carriers. The downlink transmissions may also be called forward link transmissions while the uplink transmissions may also be called reverse link transmissions. In some cases, the data being transmitted on the UL and DL over a communications link 125 may not be continuous. For example, there may be periods in which a UE 115 does not have data to transmit or receive. Thus, in some cases it may be appropriate for a UE to enter a DRX sleep period to conserve power.

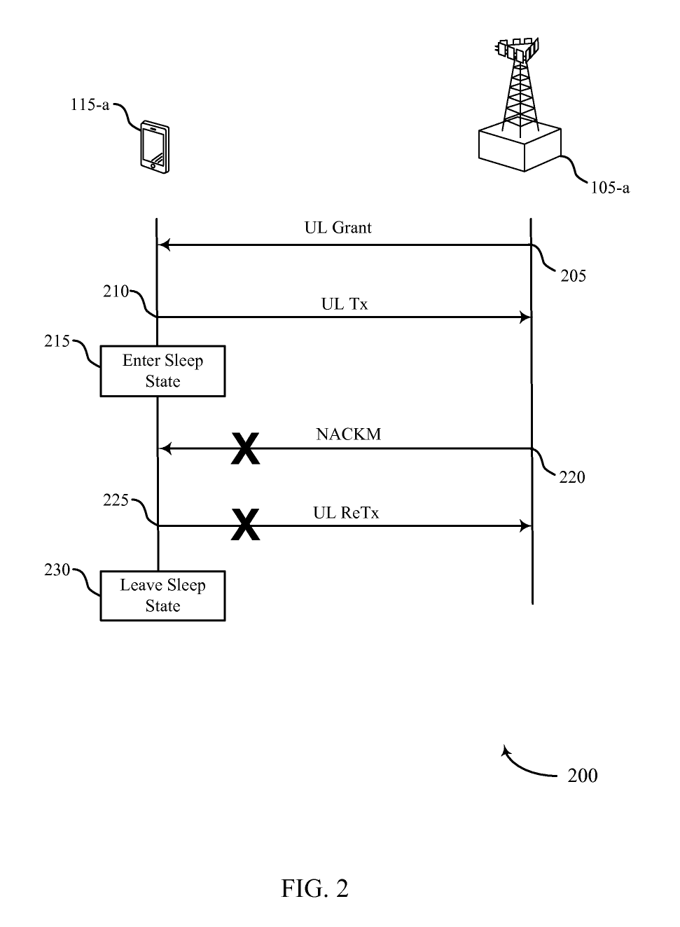

FIG. 2 illustrates an example of a wireless communication process 200 for enhanced PHICH decoding in accordance with various embodiments. A UE 115-a may receive an UL grant 205 from a base station 105-a assigning resources to the UE 115-a for an UL transmission. The UE 115-a may be an example of the UEs 115 described in FIG. 1. In addition, the base station 105-a may be an example of the base stations 105 described in FIG. 1. The UL grant 205 may be associated with a HARQ process number. The UE may send the UL transmission (Tx) 210 to the base station 105-a. In some cases, the UE 115-a does not have application layer data to transmit, and the UL Tx 210 may include MAC layer padding (e.g., and MAC Control elements such as a buffer status report (BSR)). The UE may determine that the UL Tx 210 does not include useful data, and may enter a DRX sleep period 215 based on this determination. That is, the UE may not wait for an AM (e.g., a negative ACK message (NACKM) 220 indicating unsuccessful receipt of transmission, or a positive ACK message (ACKM) indicating successful receipt of transmission) from the base station 105-a during a PHICH subframe. If the base station 105-a transmits an ACKM or NACKM 220, UE 115-a may not receive it because the UE 115-a may be in a DRX sleep state. Thus, even if the base station 105-a transmits a NACKM or another indication that the UE 115-a should send an UL ReTx 225, the UE 115-a may not send UL ReTx 225.

In another example (not shown), the UE 115-a may send an UL Tx 210 including application layer data or other useful data, and receive an ACKM from base station 105-a. In this example, the UE may enter a DRX sleep state after receiving the ACKM, and may be in the sleep state during the subframe reserved for sending UL ReTx 225. That is, if the base station sends an ACKM, the UE 115-a may infer that it may remain in a DRX sleep state because sending an UL ReTx 225 is unnecessary.

After remaining in a DRX sleep state for a period that includes the ACKM period and the UL ReTx period (e.g., or just the UL ReTx period), the UE 115-a may leave the DRX sleep state (e.g., enter DRX on-cycle 230). This may enable the UE 115-a to receive another UL grant, or otherwise participate in another HARQ process with base station 105-a.

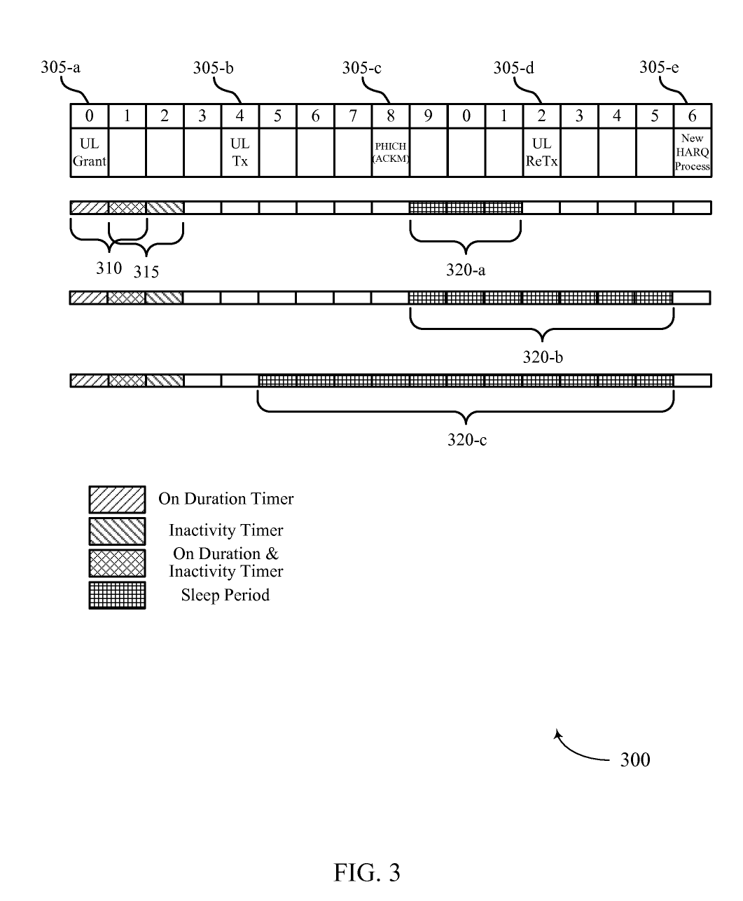

FIG. 3 illustrates an example of a DRX schedule 300 for enhanced PHICH decoding in accordance with various embodiments. Although DRX schedule 300 depicts an example of a TDD system with synchronous UL HARQ timing, other examples may include frequency division duplexing (FDD) or another system with asynchronous UL HARQ processes. The seventeen 1 millisecond subframes 305 shown are numbered from 0 to 9 based on their location within a 10 ms frame.

DRX schedule 300 depicts a HARQ process beginning with UL grant subframe 305-a (#0). DRX schedule 300 is based on a delay of 4 subframes between HARQ process elements. However, in other examples the delay may be a number other than 4. UL Tx subframe 305-b (#4) may be four subframes after UL grant subframe 305-a. PHICH (e.g., AM) subframe 305-c (#8) may be four subframes after UL Tx subframe 305-b. PHICH may be the physical channel that carries the Hybrid automatic repeat request (ARQ) Indicator (HI). The HI includes the ACKM/NACKM feedback to a UE 115 for an UL Tx received by a base station 105.

UL ReTx subframe 305-d (#2 of the next subframe) may be four subframes after PHICH subframe 305-c. An UL ReTx can either be adaptive or non-adaptive. Non-adaptive retransmissions may be triggered by a NACKM. Adaptive retransmissions may be triggered by physical downlink control channel (PDCCH) Downlink Control Information (e.g., DCI0). Subframe 305-e may be an opportunity for a new HARQ process.

At the beginning of a new HARQ process (e.g., at UL grant subframe 305-a), a UE may initiate an On Duration timer 310 to determine the duration of an active period for the DRX cycle. The UE 115 may then initiate a DRX inactivity timer 315 which may determine how long UE 115 should remain active after the reception of a PDCCH (e.g., an UL grant). When this timer is on, a UE 115 may remain in an active state even after expiration of the On Duration timer 310.

DRX sleep period 320-a is an example of a 3 subframe a sleep cycle between PHICH subframe 305-c and UL ReTx 305-d. In some cases, DRX sleep period 320-a may be used if a UE receives an adaptive or non-adaptive ReTx indication (e.g., DCI0 or NACKM) at PHICH subframe 305-c. If a ReTx indication is not received, it may be unnecessary for a UE 115 to terminate the sleep cycle for an UL ReTx. Thus, DRX sleep period 320-b is, for example, a 7 subframe DRX sleep period in which the UE 115 remains in a DRX sleep state during UL ReTx subframe 305-d.

Additionally or alternatively, in some cases, it is unnecessary for a UE 115 to decode the PHICH subframe 305-c because the HARQ process relates to an UL Tx that does not include application data. For example, an UL Tx may be sent in UL Tx subframe 305-b that includes MAC layer padding and control signaling (e.g., MAC layer padding and control signaling only). That is, the UL Tx may be a message to the base station 105 indicating that the UE 115 does not have data to send. Thus, DRX sleep period 320-c illustrates an 11 subframe, for example, DRX sleep period based on remaining in an off cycle during both PHICH subframe 305-c and UL ReTx subframe 305-d. In some cases, the DRX sleep period may be for other than 3, 7, or 11 subframes.

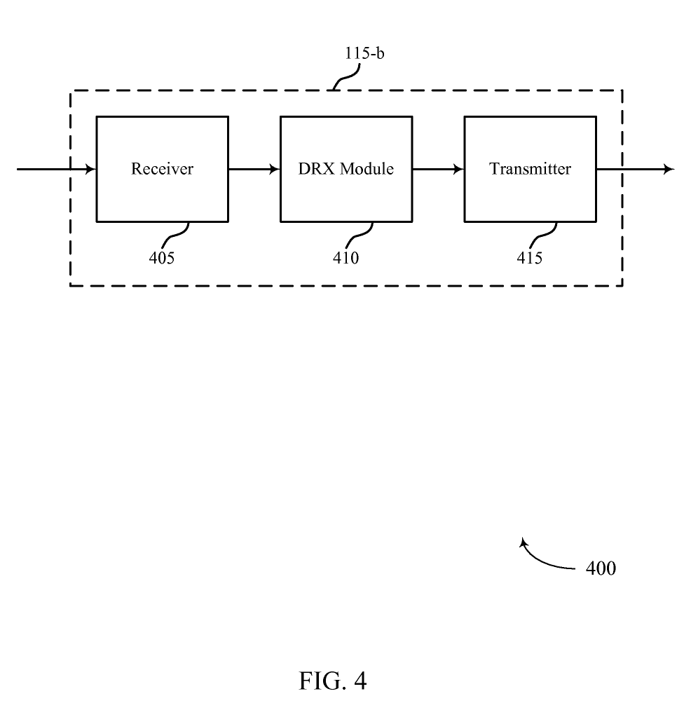

FIG. 4 shows a block diagram 400 of a UE 115-b for enhanced PHICH decoding in accordance with various embodiments. The UE 115-b may be an example of one or more aspects of a UE 115 described with reference to FIGS. 1-3. The UE 115-b may include a receiver 405, a DRX module 410, and/or a transmitter 415. The UE 115-b may also include a processor. Each of these components may be in communication with each other.

The components of the UE 115-a may, individually or collectively, be implemented with at least one application specific integrated circuit (ASIC) adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, a field programmable gate array (FPGA), or another Semi-Custom IC), which may be programmed in any manner known in the art. The functions of each unit may also be implemented, in whole or in part, with instructions embodied in a memory, formatted to be executed by one or more general or application-specific processors.

The receiver 405 may receive information such as packets, user data, and/or control information associated with various information channels (e.g., control channels, data channels, etc.). For example, receiver 405 may receive UL grants and PHICH information from a base station 105. Information may be passed on to the DRX module 410, and to other components of the UE 115-b.

The DRX module 410 may be configured to determine that an UL retransmission for a HARQ process is unnecessary based on the content of one or more messages associated with the HARQ process. For example, an UL Tx may include non-application data such as MAC layer padding. As another example, a PHICH message may indicate that an UL ReTx is unnecessary. The DRX module 410 may be configured to identify a DRX sleep period based at least in part on the determination. The DRX module 410 may be configured to cause UE 115-b to enter a DRX sleep state for the DRX sleep period. In aspects, UL Tx may include UL traffic data.

The transmitter 415 may transmit the one or more signals received from other components of the UE 115-b. For example, transmitter 415 may transmit an UL Tx or an UL ReTx to a base station 105. In some embodiments, the transmitter 415 may be collocated with the receiver 405 in a transceiver module. The transmitter 415 may include a single antenna, or it may include a plurality of antennas.

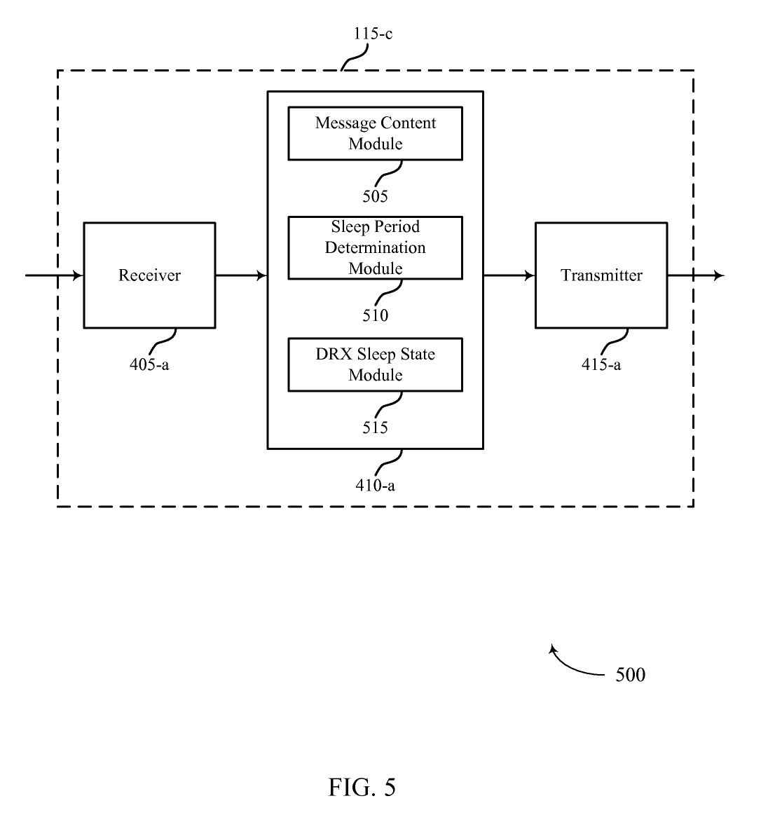

FIG. 5 shows a block diagram 500 of a UE 115-c for enhanced PHICH decoding in accordance with various embodiments. The UE 115-c may be an example of one or more aspects of a UE 115 described with reference to FIGS. 1-4. The UE 115-c may include a receiver 405-a, a DRX module 410-a, and/or a transmitter 415-a. The UE 115-c may also include a processor. Each of these components may be in communication with each other. The DRX module 410-a may include a message content module 505, a sleep period determination module 510, and/or a DRX sleep state module 515.

The components of the UE 115-c may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another Semi-Custom IC), which may be programmed in any manner known in the art. The functions of each unit may also be implemented, in whole or in part, with instructions embodied in a memory, formatted to be executed by one or more general or application-specific processors.

The receiver 405-a may receive information which may be passed on to the DRX module 410-a, and to other components of the UE 115-c. The DRX module 410-a may be configured to perform the operations described above with reference to FIG. 4. The transmitter 415-a may transmit the one or more signals received from other components of the UE 115-c.

The message content module 505 may be configured to determine that an UL retransmission for a HARQ process is unnecessary based on the content of one or more messages associated with the HARQ process. For example, the determination may be based on an UL Tx that includes non-application data. As another example, the determination may be based on a PHICH message indicating that an UL ReTx is unnecessary.

The sleep period determination module 510 may be configured to identify a DRX sleep period based at least in part on the determination. In some examples, the DRX sleep period includes an UL retransmission subframe for the HARQ process. In other examples, the DRX sleep period includes a DL AM subframe (e.g., a PHICH subframe message) associated with the HARQ process.

The DRX sleep state module 515 may be configured to enter a DRX sleep state for the DRX sleep period. For example, in a TDD system with a synchronous delay, for example, of 4 ms, the UE 115-c may enter a DRX sleep state for a period of 7 or 11 subframes, for example, as described above with reference to FIG. 3.

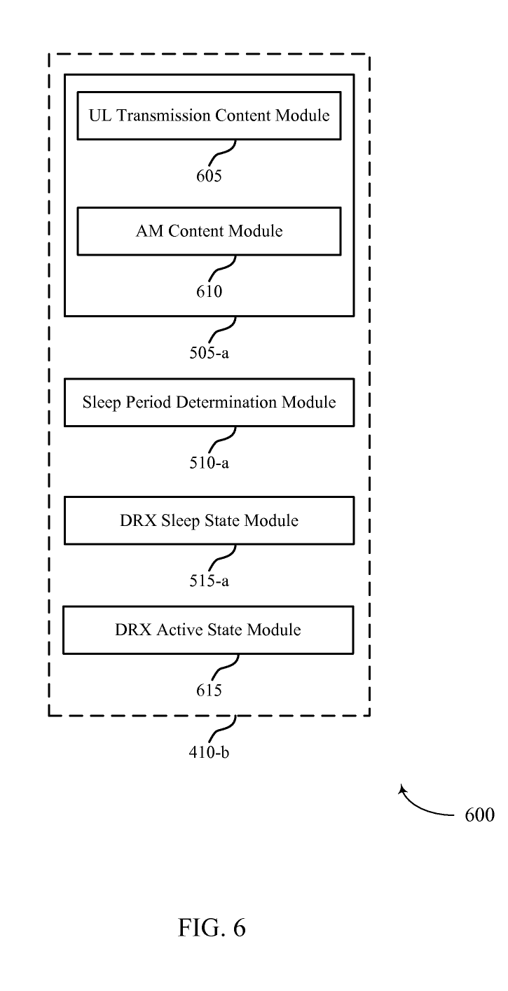

FIG. 6 shows a block diagram 600 of a DRX module 410-b for enhanced PHICH decoding in accordance with various embodiments. The DRX module 410-b may be an example of one or more aspects of a DRX module 410 described with reference to FIGS. 4-5. The DRX module 410-b may include a message content module 505-a, a sleep period determination module 510-a, and a DRX sleep state module 515-a. Each of these modules may perform the functions described above with reference to FIG. 5. The message content module 505-a may also include an UL transmission content module 605 and an AM content module 610, and a DRX active state module 615. The DRX module 410-b may also include a DRX active state module 615.

The components of the DRX module 410-b may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another Semi-Custom IC), which may be programmed in any manner known in the art. The functions of each unit may also be implemented, in whole or in part, with instructions embodied in a memory, formatted to be executed by one or more general or application-specific processors.

The UL transmission content module 605 may be configured to determine the content of an UL transmission. For example, the content may include MAC layer data such as MAC padding or a BSR. As a result, the DRX sleep period may include one or more PHICH subframe. In some examples, determining that an UL retransmission for a HARQ process may be unnecessary comprises determining that the MAC layer data includes padding data (e.g., padding data only), or that includes non-application data.

The AM content module 610 may be configured to determine the content of a PHICH message (e.g., AM). The AM content module 610 may be configured to determine that the UL retransmission is unnecessary including determining that the AM was transmitted without an indication of an adaptive or non-adaptive retransmission associated with the HARQ process (e.g., an ACKM without an adaptive retransmission indication).

The DRX active state module 615 may be configured to cause a UE 115 to enter a DRX active state after the DRX sleep period. For example, the UE may enter a DRX active (e.g., or ON) state to participate in a new HARQ process such as receiving an UL grant for an UL transmission.

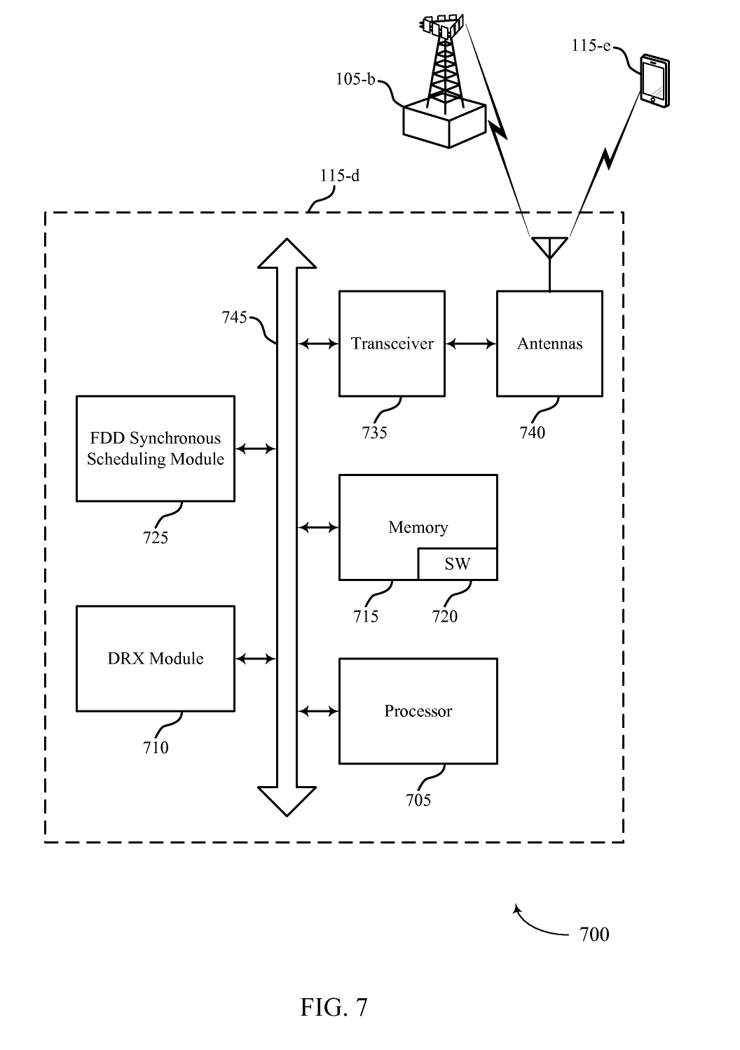

FIG. 7 shows a diagram of a system 700 for enhanced PHICH decoding in accordance with various embodiments. System 700 may include a UE 115-d, which may be an example of an UE 115 with reference to FIGS. 1-6. The UE 115-d may include a DRX module 710, which may be an example of a DRX module with reference to FIGS. 4-6. The UE 115-d may also include a FDD synchronous scheduling module 725. The UE 115-d may also include components for bi-directional voice and data communications including components for transmitting communications and components for receiving communications. For example, UE 115-d may communicate with base station 105-b or with another UE 115-e.

The FDD synchronous scheduling module 725 may be configured such that the HARQ process may be an FDD synchronous HARQ process with a delay, for example, of four subframes (or ms). In some cases, DRX sleep periods may be based at least in part on the HARQ process delay as described with reference to FIG. 3.

The UE 115-d may also include a processor module 705, and memory 715 (e.g., including software (SW) 720), a transceiver module 735, and one or more antenna(s) 740, which each may communicate, directly or indirectly, with each other (e.g., via one or more buses 745). The transceiver module 735 may be configured to communicate bi-directionally, via the antenna(s) 740 and/or one or more wired or wireless links, with one or more networks, as described above. For example, the transceiver module 735 may be configured to communicate bi-directionally with a base station 105. The transceiver module 735 may include a modem configured to modulate the packets and provide the modulated packets to the antenna(s) 740 for transmission, and to demodulate packets received from the antenna(s) 740. While the UE 115-d may include a single antenna 740, the UE 115-d may also have multiple antennas 740 capable of concurrently transmitting and/or receiving multiple wireless transmissions. The transceiver module 735 may also be capable of concurrently communicating with one or more base stations 105.

The memory 715 may include random access memory (RAM) and read only memory (ROM). The memory 715 may store computer-readable, computer-executable software/firmware code 720 including instructions that are configured to, when executed, cause the processor module 705 to perform various functions described herein (e.g., call processing, database management, processing of carrier mode indicators, reporting channel state information (CSI), etc.). Alternatively, the software/firmware code 720 may not be directly executable by the processor module 705 but be configured to cause a computer (e.g., when compiled and executed) to perform functions described herein. The processor module 705 may include an intelligent hardware device (e.g., a central processing unit (CPU), a microcontroller, an ASIC, etc.). The processor module 705 may include RAM and ROM. The memory 715 may store computer-readable, computer-executable software/firmware code 720 including instructions that are configured to, when executed, cause the processor module 705 to perform various functions described herein (e.g., call processing, database management, processing of carrier mode indicators, reporting CSI, etc.). Alternatively, the software/firmware code 720 may not be directly executable by the processor module 705 but be configured to cause a computer (e.g., when compiled and executed) to perform functions described herein. The processor module 705 may include an intelligent hardware device (e.g., a CPU, a microcontroller, an ASIC, etc.).

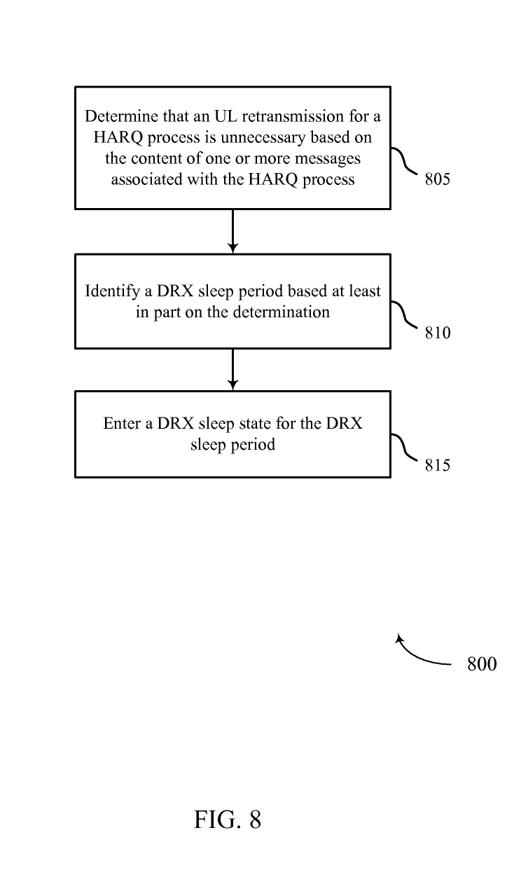

FIG. 8 shows a flowchart 800 illustrating a method for enhanced PHICH decoding in accordance with various embodiments. The functions of flowchart 800 may be implemented by a UE 115 or its components as described with reference to FIGS. 1-7. In certain examples, the blocks of the flowchart 800 may be performed by the DRX module with reference to FIGS. 4-7.

At block 805, the UE 115 may determine that an UL retransmission for a HARQ process is unnecessary based on the content of one or more messages associated with the HARQ process. In certain examples, the functions of block 805 may be performed by the message content module 505 as described above with reference to FIG. 5.

At block 810, the UE 115 may determine or identify a DRX sleep period based at least in part on the determination. In certain examples, the functions of block 810 may be performed by the sleep period determination module 510 as described above with reference to FIG. 5.

At block 815, the UE 115 may enter a DRX sleep state for the DRX sleep period. In certain examples, the functions of block 815 may be performed by the DRX sleep state module 515 as described above with reference to FIG. 5.

It should be noted that the method of flowchart 800 is just one implementation and that the operations of the method, and the steps may be rearranged or otherwise modified such that other implementations are possible.

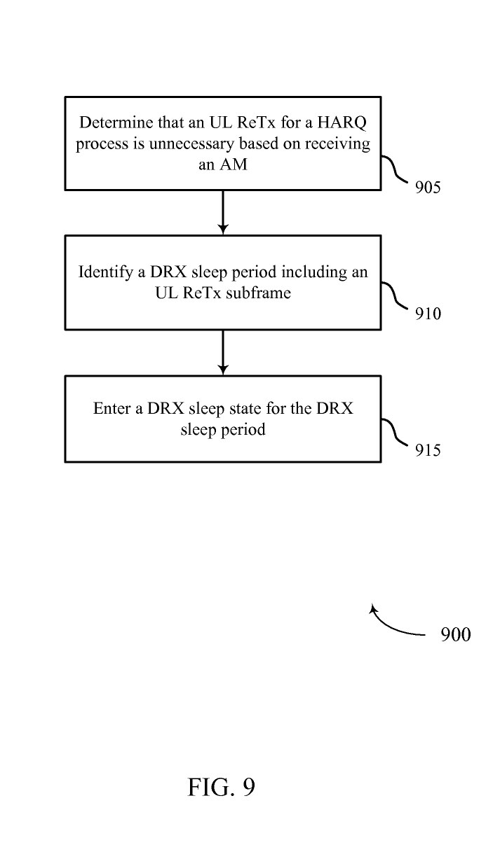

FIG. 9 shows a flowchart 900 illustrating a method for enhanced PHICH decoding in accordance with various embodiments. The functions of flowchart 900 may be implemented by a UE 115 or its components as described with reference to FIGS. 1-7. In certain examples, the blocks of the flowchart 900 may be performed by the DRX module with reference to FIGS. 4-7. The method described in flowchart 900 may incorporate aspects of flowchart 800 of FIG. 8.

At block 905, the UE 115 may determine that an UL ReTx for a HARQ process is unnecessary based on receiving an AM (e.g., an ACKM without an adaptive retransmission indication). In certain examples, the functions of block 905 may be performed by the message content module 505 as described above with reference to FIG. 5 and/or the AM content module 610 with reference to FIG. 6.

At block 910, the UE 115 may determine or identify a DRX sleep period based at least in part on the determination. The DRX sleep period may include an UL ReTx subframe as described with reference to FIG. 3. In certain examples, the functions of block 910 may be performed by the sleep period determination module 510 as described above with reference to FIG. 5.

At block 915, the UE 115 may enter a DRX sleep state for the DRX sleep period. In certain examples, the functions of block 915 may be performed by the DRX sleep state module 515 as described above with reference to FIG. 5.

It should be noted that the method of flowchart 900 is just one implementation and that the operations of the method, and the steps may be rearranged or otherwise modified such that other implementations are possible.

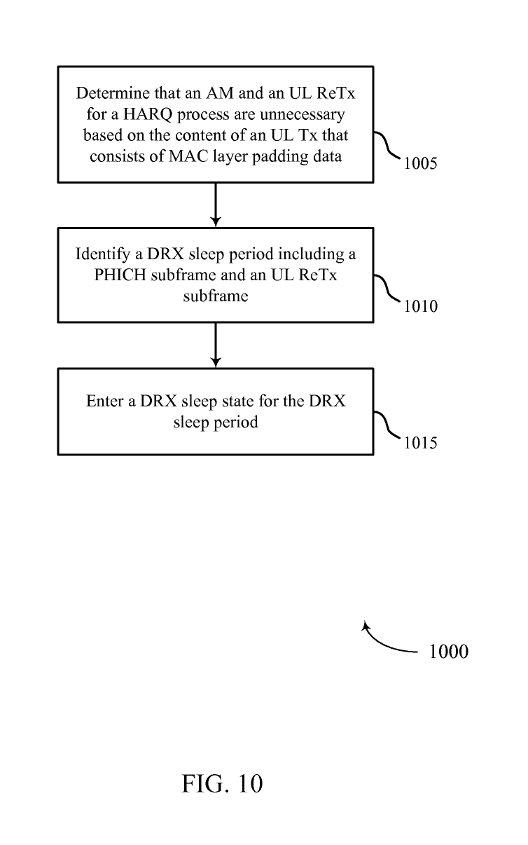

FIG. 10 shows a flowchart 1000 illustrating a method for enhanced PHICH decoding in accordance with various embodiments. The functions of flowchart 1000 may be implemented by a UE 115 or its components as described with reference to FIGS. 1-7. In certain examples, the blocks of the flowchart 1000 may be performed by the DRX module with reference to FIGS. 4-7. The method described in flowchart 1000 may incorporate aspects of flowcharts 800 of FIG. 8.

At block 1005, the UE 115 may determine that receiving an AM (e.g., decoding a PHICH subframe) and transmitting an UL ReTx for a HARQ process are unnecessary based on the content of an UL Tx, for example, that includes MAC layer padding data. In certain examples, the functions of block 1005 may be performed by the message content module 505 as described above with reference to FIG. 5 or the UL transmission content module 605 with reference to FIG. 6.

At block 1010, the UE 115 may identify a DRX sleep period based at least in part on the determination. The DRX sleep period may include a PHICH (e.g., AM) subframe and an UL ReTx subframe. In certain examples, the functions of block 1010 may be performed by the sleep period determination module 510 as described above with reference to FIG. 5.

At block 1015, the UE 115 may enter a DRX sleep state for the DRX sleep period. In certain examples, the functions of block 1015 may be performed by the DRX sleep state module 515 as described above with reference to FIG. 5.

It should be noted that the method of flowchart 1000 is just one implementation and that the operations of the method, and the steps may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of [at least one of A, B, or C] means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable read only memory (EEPROM), compact disk (CD)ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method of wireless communication at a user equipment (UE), comprising:
determining that an uplink (UL) retransmission for a hybrid automatic repeat request (HARQ) process is unnecessary based on the content of one or more messages associated with the HARQ process;
identifying a discontinuous reception (DRX) sleep period based at least in part on the determination; and
entering a DRX sleep state for the DRX sleep period.

2. The method of claim 1, wherein the DRX sleep period includes an UL retransmission subframe for the HARQ process.

3. The method of claim 1, wherein the one or more messages includes an UL transmission and the content comprises medium access control (MAC) layer data.

4. The method of claim 3, wherein the DRX sleep period includes a physical HARQ indicator channel (PHICH) subframe for the HARQ process.

5. The method of claim 3, wherein determining that an UL retransmission for a HARQ process is unnecessary comprises:
determining that the MAC layer data includes MAC layer padding data.

6. The method of claim 3, wherein the content includes non-application data.

7. The method of claim 1, wherein the one or more messages includes an acknowledgement message (AM) associated with the HARQ process.

8. The method of claim 7, further comprising:
determining that the AM was transmitted without an indication of an adaptive retransmission associated with the HARQ process.

9. The method of claim 1, wherein the DRX sleep period comprises subframes between an acknowledgement message (AM) associated with the HARQ process and a new HARQ process.

10. The method of claim 1, wherein the DRX sleep period comprises subframes between an uplink transmission associated with the HARQ process and a new HARQ process.

11. The method of claim 1, further comprising:
entering a DRX active state after the DRX sleep period.

12. The method of claim 1, wherein the DRX sleep period includes a downlink (DL) AM subframe associated with the HARQ process.

13. An apparatus for wireless communication at a user equipment (UE), comprising:
means for determining that an uplink (UL) retransmission for a hybrid automatic repeat request (HARQ) process is unnecessary based on the content of one or more messages associated with the HARQ process;
means for identifying a discontinuous reception (DRX) sleep period based at least in part on the determination; and
means for entering a DRX sleep state for the DRX sleep period.

14. An apparatus for wireless communication at a user equipment (UE), comprising a processor, memory in electronic communication with the processor and instructions stored in the memory, the instructions being executable by the processor to:
determine that an uplink (UL) retransmission for a hybrid automatic repeat request (HARQ) process is unnecessary based on the content of one or more messages associated with the HARQ process;
identify a discontinuous reception (DRX) sleep period based at least in part on the determination; and
enter a DRX sleep state for the DRX sleep period.

15. The apparatus of claim 14, wherein the DRX sleep period includes an UL retransmission subframe for the HARQ process.

16. The apparatus of claim 14, wherein the one or more messages includes an UL transmission and the content comprises medium access control (MAC) layer data.

17. The apparatus of claim 16, wherein the DRX sleep period includes a physical HARQ indicator channel (PHICH) subframe for the HARQ process.

18. The apparatus of claim 16, wherein determining that an UL retransmission for a HARQ process is unnecessary comprises:
determining that the MAC layer data includes MAC layer padding data.

19. The apparatus of claim 16, wherein the content includes non-application data.

20. The apparatus of claim 14, wherein the one or more messages includes an acknowledgement message (AM) associated with the HARQ process.

21. The apparatus of claim 20, the instructions being further executable by the processor to:
determine that the AM was transmitted without an indication of an adaptive retransmission associated with the HARQ process.

22. The apparatus of claim 14, wherein the DRX sleep period comprises subframes between an acknowledgement message (AM) associated with the HARQ process and a new HARQ process.

23. The apparatus of claim 14, wherein the DRX sleep period comprises subframes between an uplink transmission associated with the HARQ process and a new HARQ process.

24. The apparatus of claim 14, the instructions being further executable by the processor to:
enter a DRX active state after the DRX sleep period.

25. The apparatus of claim 14, wherein the DRX sleep period includes a downlink (DL) AM subframe associated with the HARQ process.

26. A non-transitory computer-readable medium storing code for wireless communication at a user equipment (UE), the code comprising instructions executable by a processor to:
determine that an uplink (UL) retransmission for a hybrid automatic repeat request (HARQ) process is unnecessary based on the content of one or more messages associated with the HARQ process;
identify a discontinuous reception (DRX) sleep period based at least in part on the determination; and
enter a DRX sleep state for the DRX sleep period.

27. The non-transitory computer-readable medium of claim 26, wherein the DRX sleep period includes an UL retransmission subframe for the HARQ process.

28. The non-transitory computer-readable medium of claim 26, wherein the one or more messages includes an UL transmission and the content comprises medium access control (MAC) layer data.

29. The non-transitory computer-readable medium of claim 28, wherein the DRX sleep period includes a physical HARQ indicator channel (PHICH) subframe for the HARQ process.

30. The non-transitory computer-readable medium of claim 28, wherein determining that an UL retransmission for a HARQ process is unnecessary comprises:
determining that the MAC layer data includes MAC layer padding data.
